(19) United States
(12) Patent Application Publication
(10) Pub. No.: US 2005/0026788 A1
(43) Pub. Date: Feb. 3, 2005

(54) Metal strip for epitaxial coatings and method for production thereof

(76) Inventors: Jutta Kloewer, Hemer (DE); Bernd De Boer, Altena (DE); Sarma Vadlamani, Chennai (IN)

Correspondence Address: JORDAN AND HAMBURG LLP, 122 EAST 42ND STREET, SUITE 4000, NEW YORK, NY, 10168, US

(21) Appl. No.: 10/498,435

(22) PCT Filed: Dec. 15, 2002
(86) PCT No.: PCT/DE02/04663

(30) Foreign Application Priority Data
Jan. 2, 2002 (DE) 102 00 445.5

(51) Int. Cl. H01B 1/00

(52) U.S. Cl. 505/100

(57) ABSTRACT

The invention relates to a metal strip made from a layer composite for epitaxial coating and a method for production thereof. The aim of the invention is to produce such a high-strength metal strip and a corresponding production method. Said metal strip is a layer composite made from at least one biaxially-textured base layer of the metals Ni, Cu, Ag or alloys thereof and at least one further metallic layer, whereby the individual further metallic layers are made from one or several intermetallic phases or from a single metal in which one or several intermetallic phases are contained. The production method is characterized in that the formation of intermetallic phases at the end of the production process is carried out by means of interdiffusion of elements provided in the layers. Such strips can be advantageously used, for example, as support strips for the deposition of biaxial textured layers made from YBa₂Cu₃Oₓ high temperature superconducting material. Said high temperature superconductors are particularly suitable for application in energy technology.

The invention relates to a metal strip, consisting of a laminar composite, for epitaxial coatings and to a method for producing such a strip. Such strips can be used advantageously, for example, as a backing for the deposition of biaxially textured layers of YBa₂Cu₃Oₓ high-temperature superconducting material. Such superconductors are suitable especially for uses in energy technology.

Metal strips, which are based on nickel, copper and silver and are suitable for being coated epitaxially with a biaxially textured layer, are already known (U.S. Pat. Nos. 5,739,086, 5,741,377, 5,964,966 and 5,968,877). They are produced by cold rolling with a degree of deformation of more than 95% and a subsequent recrystallization annealing, a sharp [001]<100> texture (cubic texture) being formed.

Intensive work has been carried out worldwide especially on the development of substrate materials based on nickel and silver (J. E. Mathis et al., Jap. J. Appl. Phys. 37, 1998; T. A. Gladstone et al., Inst. Phys. Conf. Ser. No. 167, 1999). Known efforts to increase the strength of the material have involved either mixed crystal hardening, for which a nickel alloy typically is rolled with more than 5% of one or more alloying elements and recrystallized (U.S. Pat. No. 5,964,966; G. Celentano et al. Journal of Modern Physics B, 13, 1999, page 1029; R. Nekkanti et al., Presentation at the Applied Supercond. Conf., Virginia Beach, Va., Sep. 17-22, 2000) or a composite of nickel with a material of higher tensile strength, obtained by rolling and recrystallization (T. Watanabe et al., Presentation at the Applied Supercond. Conf., Virginia Beach, Va., Sep. 17-22, 2000)).

For mixed crystal hardening, there is a critical degree of alloying, above which the cubic texture can no longer be formed. This phenomenon has been investigated intensively for brass alloys (copper-zinc alloys with an increasing zinc content) and appears to have general validity (H. Hu et al., Trans. AIME, 227, 1963, page 627; G. Wassermann, J. Grewen: Texturen metallischer Werkstoffe (Texturing Metallic Materials, Springer Verlag Berlin/Göttingen/Heidelberg). Since the strength increases steadily with the concentration of alloy, a maximum strength is also associated with this. The second limitation is the fact that the material already has a high strength during the deformation by rolling. As a result, very high rolling forces arise during the necessarily high degree of deformation, as a result of which, on the one hand, the rolling mill must satisfy higher requirements and, on the other, it becomes technically more difficult to carry out the exceptionally homogeneous rolling deformation, which is required for forming the necessary, high-grade cubic texture.

For increasing the strength of a composite by rolling, there is also the problem that high rolling forces are required for the extensive deformation of a very stable material. Because of the differences in the mechanical properties of the two materials forming the composite, inhomogeneities in the deformation microstructure occur, which decrease the quality of the cubic texture attainable during the recrystallization process.

The strength of intermetallic phases is clearly higher than that of mixed crystal alloys. The former are, however, brittle, as a result of which they cannot be processed into a thin strip with a pronounced cubic texture.

Especially for so-called intermetallic γ′⁻ and γ″⁻ phases (Ni₃Al, Ni₃Ti, Ni₃Nb), it is known that the strength even increases with increasing temperature, instead of decreasing, as it does in the case of mixed crystals. As a result, a strip, which is reinforced by such phases, has a strength, which is much higher than that of conventional strips especially at the critically high temperatures (in excess of 600° C.), which occur during a coating.

It is therefore an object of the invention to create a metal strip for epitaxial coatings, which has a particularly high strength. Included in this object is the development of a method, which enables such high-strength metal strip to be produced industrially without problems.

With a metal strip, which consists of a laminar composite, this objective is accomplished owing the fact that the laminar composite consists of at least one biaxially textured basic layer of the metals nickel, copper and silver or their alloys and at least one further metallic layer, the individual, further metallic layers consisting of one or more intermetallic phases or of a metal, in which one or more intermetallic phases are contained.

In accordance with a first, appropriate development of the invention, the individual, further metallic layers, in the case of biaxially textured basic layers of nickel or nickel alloys, consist of intermetallic phases of the basic layer metal with at least one of the metals Al, Ta, Nb and Ti or their alloys.

In accordance with a second appropriate development of the invention, the individual, further metallic layers, in the case of biaxially textured basic layers of nickel or nickel alloys, consists of at least one of the metals Al, Ta, Nb and Ti or their alloys, in which intermetallic phases of the metals Al, Ta, Nb and Ti or their alloys with this basic layer medal are contained.

Appropriately, the intermetallic phases may consist of NiAl, Ni₃Al, Al₃Ni₂, Al₂Ni, NiTa, NiTa₂, Ni₃Ta, Ni₃Nb and/or Ni₆Nb₇.

In accordance with a further appropriate development of the invention, the individual, further metallic layers, in the case of biaxially textured basic layers of copper or copper alloys, consist of intermetallic phases of zinc and copper or copper alloy.

In the case of biaxially textured basic layers of copper or copper alloys, the individual, further metallic layers may also consist of zinc, in which intermetallic phases of copper or of the copper alloy with zinc are contained.

The intermetallic phases of the copper or copper alloy with zinc are β brass and/or γ brass.

In accordance with a further appropriate development of the invention, the individual, further metallic layers, in the case of biaxially textured basic layers of silver or silver alloys, consist of intermetallic phases of neodymium and silver or of the silver alloy.

In the case of biaxially textured basic layers of silver or silver alloys, the individual, further metallic layers may also consist of neodymium, in which intermetallic phases of the silver or of the silver alloy with the neodymium are contained.

The intermetallic phases of silver or of the silver alloy with neodymium consist of Ag₅₂Nd₁₄, Ag₂Nd and/or AgNd.

In accordance with an advantageous development of the invention, the laminar composite consists of two of the biaxially textured basic layers and one of the further, metallic layers, the further metallic layer being disposed between the biaxially textured layers.

In order to produce such metallic strips, the invention includes a method, for which, initially the laminar composite is produced, which consists of at least one layer of the metals nickel, copper and silver or their alloy, which is suitable for biaxial texturing, and at least one further metallic layer. In the further metallic layers, at least one element must be contained, which can form intermetallic phases with the elements of the layers suitable for biaxial texturing.

After that, this laminar composite is rolled with a degree of deformation of at least 90% into a strip. Finally, by subjecting the strip to a heat treatment at a temperature between 300° and 1100° C., the desired texture of the intermetallic phases is formed in the layers suitable for a biaxial texturing and in the further layers by interdiffusion over the interfaces of the connected layers.

The laminar composite is produced in an appropriate manner by cladding and the rolling of the laminar composite into a strip is carried out with a degree of deformation of at least 95%. Temperatures between 500° and 900° C. are particularly suitable for the heat treatment of the strip.

In a modification of the inventive method, a biaxially textured strip of nickel, copper or silver or their alloys is produced, to begin with, by rolling and recrystallizing. Subsequently, this strip is coated with at least one further metallic phase, which contains at least one metal, which can form intermetallic phases with the elements in the biaxially textured strip. Possible coating methods include, for example, electrical and chemical methods or also depositions from the vapor phase. During a subsequent heat treatment, the strengthening intermetallic phase is formed starting out from the interfacial layer.

As an alternative to coating, it is also possible, if the melting point of the biaxially textured strip is clearly above that of the further metallic phase, to wet the biaxially textured strip on one side with the further metallic phase in liquid form. Diffusion from the liquid phase into the biaxially textured strip then takes place, so that the intermetallic phases can be formed starting out from the surface of the biaxially textured strip.

Biaxially textured metallic strip of high strength can be produced in a relatively simple manner with the inventive method. In this connection, it is of particular advantage that the strip has an advantageously low strength and a high ductility for the deformation steps of the method, since the intermetallic phases of high strength are formed in the strip only during the subsequent annealing treatment. The formation of a cubic texture is not affected by the different kinetics of the processes of recrystallization and diffusion.

The inventive strip is suitable particularly as a backing strip for the deposition of biaxially textured layers of YBa₂Cu₃Oₓ high-temperature superconducting material. Such superconductors can be used advantageously in energy technology.

The invention is described in greater detail below by means of examples.

### EXAMPLE 1

Through cladding by rolling, a laminar composite, consisting of three layers, is produced from the metals nickel and aluminum in the sequence Ni/Al/Ni. The thickness of the nickel layers is 1.5 mm and that of the aluminum layer 0.5 mm. This laminar composite is rolled into a strip 80 μm thick. The strip subsequently is aged for several hours at a temperature of 600° C. in a reducing atmosphere. The strip is recrystallized within the first few seconds of this heat treatment. In the further course of this heat treatment, NiAl phases of different stoichiometry arise and grow at the interfacial layers.

The surface of the finished strip has a high-grade cubic texture and is suitable for being coated on both sides epitaxially with a biaxially textured layer.

The yield point of the strip at room temperature is approximately 100 MPa and does not change up to a temperature of 600° C. As a result, this material has a much higher strength at the coating temperature, especially in comparison to a mixed crystal, hardened strip.

### EXAMPLE 2

Through cladding by rolling, a laminar composite, consisting of three layers, is produced from the metals nickel and niobium in the sequence Ni/Nb/Ni. The thickness of the nickel the layer is 1.5 mm and that of the niobium layer is 0.5 mm. This laminar composite is rolled into a strip 40 μm thick. The strip subsequently is aged for one hour at a temperature of 900° C. in a reducing atmosphere. The strip is recrystallizing within the first few minutes of this heat treatment. In the further course of this heat treatment, NiNb phases of different stoichiometry arise and grow at the interfacial layers.

The surface of the finished strip has a high-grade cubic texture and is also suitable for being coated on both sides epitaxially with a biaxially textured layer.

The yield point of the strip at room temperature is approximately 85 MPa and does not change up to a temperature of 600° C. As a result, this material has a much higher strength at the coating temperature, especially in comparison with mixed crystal, hardened strip.

### EXAMPLE 3

A 40 μm thick, biaxially textured strip of pure nickel, produced by rolling and recrystallizing, is heated to a temperature of 800° C. and covered on the side, which is not to be coated, with a 10 μm thick aluminum foil. As a result of the heat treatment, the aluminum foil melts and the aluminum diffuses into the nickel, so that intermetallic NiAl phases of different stoichiometry are formed by interdiffusion, which starts out from the surface of the nickel strip.

The yield point of the strip at room temperature is approximately 90 MPa and does not change up to a temperature of 600° C. As a result, this material has a much higher strength at the coating temperature, especially in comparison with mixed crystal, hardened strip.

### EXAMPLE 4

Through cladding by rolling, a laminar composite, consisting of three layers, is produced from the metals copper and zinc in the sequence Cu/Zn/Cu. The thickness of the copper layers is 1.5 mm and that of the zinc layer 0.7 mm. This laminar composite is rolled into a strip 50 μm thick. The strip is subsequently heated at 30° K/min to 800° C. and maintained at this temperature for a further 60 minutes. During this annealing, a sharp cubic texture is formed at first and, subsequently, brass phases of different stoichiometry are formed, starting out from the copper-zinc interface.

The surface of the finished strip has a high-grade cubic texture and is suitable for being coated on both sides epitaxially with a biaxially textured layer. The yield point of the strip at room temperature is approximately 80 MPa and decreases to 30 MPa as the temperature increases to 750° C. As a result, the strip is clearly firmer than other copper alloy strip with a comparably highly developed biaxial texture.

1. Metal strip for epitaxial coatings comprising a laminar composite, the laminar composite comprising at least one biaxially textured basic layer of the metals nickel, copper and silver or their alloys and at least one further metallic layer, the individual further metallic layers comprising one or more intermetallic phases or of a metal in which one or more intermetallic phases is/are contained.

2. The metal strip of claim 1, wherein, in the case of biaxially textured basic layers of nickel or nickel alloys, the individual further metallic layers comprising intermetallic phases of the basic layer metal with at least one of the metals aluminum, tantalum, niobium and titanium or their alloys.

3. The metal strip of claim 1, wherein in the case of biaxially textured basic layers of nickel or nickel alloys, the individual further metallic layers comprising at least one of the metals aluminum, tantalum, niobium and titanium or their alloys with intermetallic phases of the metals aluminum, tantalum, niobium and titanium contained therein or of their alloys with the basic coating metal.

4. The metal strip of claims 2 or 3, wherein the intermetallic phases comprises NiAl, Ni₃Al, Al₃Ni₂, Al₂Ni, NiTa, NiTa₂, Ni₃Ta, Ni₃Nb and/or NiNb₇.

5. The metal strip of claim 1, wherein in the case of biaxially textured basic layers of copper or copper alloys, the individual further metallic layers comprises intermetallic phases of zinc and copper or of the copper alloy.

6. The metal strip of claim 1, wherein in the case of biaxially textured basic layers of copper or copper alloys, the individual further metallic layers comprises zinc, in which intermetallic phases of copper or of the copper alloy with zinc are contained.

7. The metal strip of claims 5 or 6, wherein the intermetallic phases of copper or of the copper alloy with the zinc comprises β brass and/or γ brass.

8. The metal strip of claim 1, wherein in the case of biaxially textured basic layers of silver or of silver alloys, the individual further metallic layers comprises intermetallic phases of neodymium and silver or the silver alloy.

9. The metal strip of claim 1, wherein in the case of biaxially textured basic layers of silver or of silver alloys, the individual further metallic layers comprises neodymium, in which intermetallic phases of silver or of the silver alloy with neodymium are contained.

10. The metal strip of claims 8 or 9, wherein the intermetallic phases of silver or of the silver alloy with the neodymium comprises Ag₅₂Nd₁₄, Ag₂Nd and/or of Ag/Nd.

11. The metal strip off claim 1, wherein the laminar composite comprises two of the biaxially textured basic layers and one of the further metallic layers, the further metallic layer being disposed between the biaxially textured layers.

12. Method for producing a metal strip of one of the claims 1 to 3, wherein initially, a laminar composite is produced, which comprises at least one layer of the metals nickel, copper and silver or their alloy, suitable for biaxial texturing, and at least one further metallic layer, at least one element, which can form intermetallic phases with the elements of the layers suitable for biaxial texturing, being contained in the further, metallic layers, subsequently this laminar composite is rolled with a degree of deformation of at least 90% into a strip, and that finally, by means of a heat treatment of the strip at a temperature between 300° and 1100° C., the desired texture is formed in the layers suitable for biaxial texturing and in the further layers by interdiffusion over the interfaces of the layers connected by intermetallic phases.

13. The method of claim 12, wherein the laminar composite is produced by cladding.

14. The method of claim 12, wherein the rolling of the laminar composite is carried out with a degree of deformation of at least 95%.

15. Method for producing a metal strip of one of the claims 1 to 3, wherein initially, by rolling and recrystallization, a biaxially textured strip of nickel, copper and silver or their alloys is produced, that subsequently this strip is coated with at least one further metallic phase, which contains at least one metal, which can form intermetallic phases with the elements in the biaxially textured strip, and that, starting out from the interface, the strengthening intermetallic phase is formed during a subsequent heat treatment.

16. The method for producing a metal strip of claim 15, wherein an electrolytic or chemical procedure or also a deposition from the vapor phase is used for the coating.

17. The method of claims 12 or 15, claim 12, wherein the heat treatment is carried out at temperatures between 500° and 900° C.

18. The method for producing a metal strip of claim 15, wherein if the melting point of the biaxially textured strip is clearly above that of the further metallic phase, the biaxially textured strip is wetted on one side with the further metallic phase in the liquid form.

19. Use of the metal strip of one of the claims 1 to 3 as a backing strip for the deposition of biaxially textured layers of YBa₂Cu₂Oₓ high-temperature superconducting material for producing strip-shaped high-temperature superconductors.

20. The use of the high-temperature superconductors, produced according to claim 19, in energy technology.

21. The method of claim 15, wherein the heat treatment is carried out at temperatures between 500° and 900° C.
